(19) United States
(12) Patent Application Publication
(10) Pub. No.: US 2025/0127157 A1
(43) Pub. Date: Apr. 24, 2025

(54) MODULAR PEST SCOUTING SYSTEM

(71) Applicant: BARN OWL TECHNOLOGIES CORP., Boston, MA (US)

(72) Inventors: Richard CHEN, Wellesley, MA (US); Behrooz AZIMZADEH ISMALI KANDI, Ithaca, NY (US); Scott SMITH, Cambridge, MA (US)

(73) Assignee: BARN OWL TECHNOLOGIES CORP., Boston, MA (US)

(21) Appl. No.: 18/920,352

(22) Filed: Oct. 18, 2024

Related U.S. Application Data
(60) Provisional application No. 63/544,877, filed on Oct. 19, 2023.

(51) Int. Cl. A01M 23/14; A01M 23/00

(52) U.S. Cl. CPC A01M 23/14; A01M 23/005

(57) ABSTRACT

A modular pest scouting system includes a trapping module and a pest redirect module. The trapping module is for catching pests. The pest redirect module is detachably attached to the trapping module. The pest redirect module is for luring the pests to move toward the trapping module so as to be caught by the trapping module.

### CROSS-REFERENCE TO RELATED APPLICATION

This application claims the benefit of U.S. Provisional Patent Application No. 63/544,877, filed on Oct. 19, 2023, the entire disclosure of which is incorporated by reference herein.

### FIELD

The disclosure relates to a pest scouting system, and more particularly to a modular pest scouting system.

### BACKGROUND

Conventionally, for monitoring and/or scouting various kinds of pests, various kinds of pest scouting systems with different configurations may be needed. Preparing these structurally different pest scouting systems may be costly.

### SUMMARY

Therefore, an object of the disclosure is to provide a modular pest scouting system that can alleviate the drawback of the prior art.

According to an aspect of the disclosure, the modular pest scouting system includes a trapping module and a pest redirect module. The trapping module is for catching pests. The pest redirect module is detachably attached to the trapping module for luring the pests to move toward the trapping module.

According to another aspect of the disclosure, the modular pest scouting system includes a trapping module, a trapping unit and a cleaning mechanism. The trapping module is for catching pests. The trapping unit is associated with the trapping module for ensuring the pests caught by the trapping module to remain on trapping module. The cleaning mechanism is associated with the trapping module for renewing the trapping unit.

According to still another aspect of the disclosure, the modular pest scouting system is fastened onto a supporting stand, and includes a trapping module for catching pests. The trapping module includes a trapping box, and an arm that is rotatably mounted to the supporting stand and that is fixedly connected to the trapping box.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a schematic side view illustrating an example modular pest scouting system according to the disclosure.

FIG. 2 is a perspective view illustrating an example lure holder of the example modular pest scouting system.

FIG. 3 is a schematic side view illustrating another example modular pest scouting system according to the disclosure.

FIG. 4 is a fragmentary perspective view illustrating another example modular pest scouting system according to the disclosure.

FIG. 5 is a fragmentary perspective view illustrating an example cleaning mechanism of the example modular pest scouting system in FIG. 4 in an unloading state.

FIG. 6 is a fragmentary perspective view illustrating an example revolving door of another example modular pest scouting system in a blocking position.

FIG. 7 is a fragmentary perspective view illustrating the example revolving door of the example modular pest scouting system in FIG. 7 in an opening position.

FIG. 8 is a fragmentary perspective view illustrating another example modular pest scouting system according to the disclosure.

FIG. 9 is a fragmentary perspective view illustrating another example modular pest scouting system according to the disclosure.

FIG. 10 is a fragmentary perspective view illustrating an example cleaning mechanism of the example modular pest scouting system in FIG. 9.

FIGS. 11 to 13 are schematic side views illustrating operation of the example cleaning mechanism of the example modular pest scouting system in FIG. 9.

FIG. 14 is a perspective view illustrating an example tray of the example cleaning mechanism in FIG. 9 and an example redirect module.

FIGS. 15 and 16 are schematic side views illustrating operation of the example cleaning mechanism of the example modular pest scouting system in FIG. 9.

FIG. 17 is a block diagram illustrating still another example modular pest scouting system according to the disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein May be interpreted accordingly.

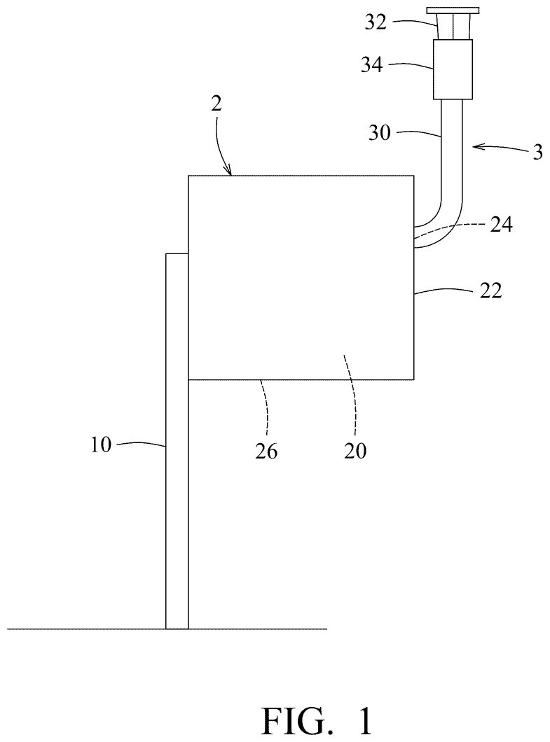

Referring to FIG. 1, an example modular pest scouting system for monitoring and/or scouting pests is fastened onto a supporting stand 10. The supporting stand 10 may be a wooden pole, a tree, a tripod, a stake, or the like. In the illustrated example, the modular pest scouting system may include a trapping module 2 for catching pests. In some examples, lure/stimuli, such as light, scent, or other attractants, may be attached to the trapping module 2 for luring pests to move toward the trapping module 2.

In some examples, the trapping module 2 may include a trapping box 22 that defines a trapping chamber 20, and a trapping opening 24 that is in spatial communication with the trapping chamber 20. In some examples, lure/stimuli may be attached to the trapping module 2 or may be disposed in the trapping chamber 20 for luring pests to enter the trapping chamber 20 via the trapping opening 24. In some examples, the modular pest scouting system may further include a trapping unit 26 to ensure the pests stay in the trapping module 2. For example, the trapping unit 26 may include a sticky board disposed on an inner bottom of the trapping box 22. The sticky board contains adhesive thereon, so as to retain the pests with smaller tarsus. In some examples, the trapping unit 26 may be in the form of a slippery layer on an inner surface of the trapping box 22. For example, the material of the slippery layer may be selected to be slippery for the pests to climb (and therefore prevent the pests from escaping), such as acrylic. In some examples, the inner side of the trapping box 22 may be applied with specific coatings that serve as the trapping unit 26, so as to make the inner surface of the trapping box 22 more slippery. In some examples, the trapping box 22 may be made of a material that is slippery for the pests to climb, and an inner wall of the trapping box may serve as the trapping unit 26. In some examples, various structures may be employed to ensure that the pests stay in the trapping module 2, and is not limited to the manner described above. In some examples, the trapping box 22 may be formed using a transparent material for remote monitoring.

In some examples, the modular pest scouting system may further include a pest redirect module 3 that is attached to the trapping module 2. In some examples, the pest redirect module 3 may be detachably connected to the trapping module 2.

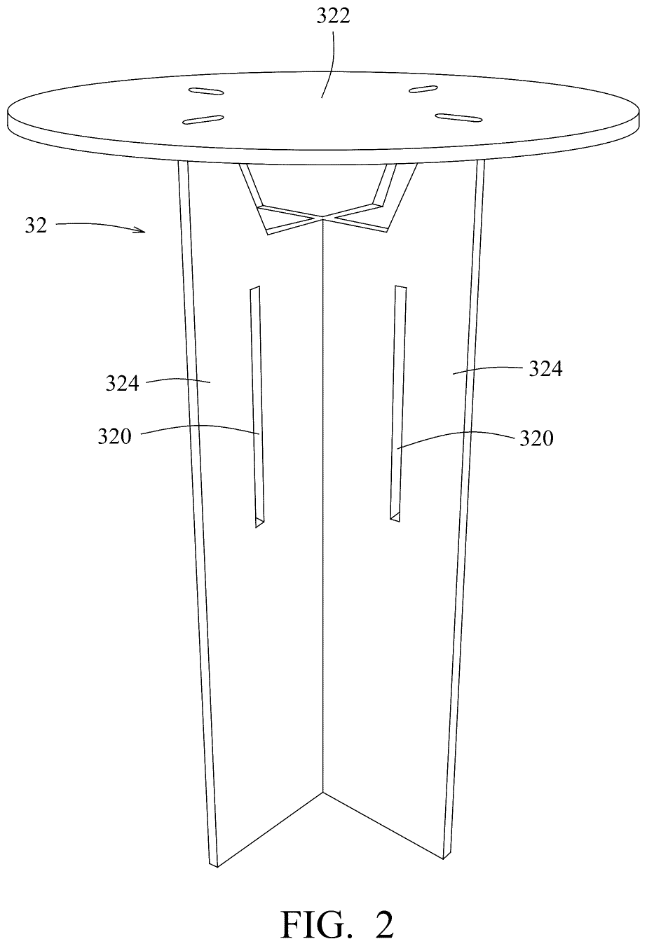

In the illustrated example in FIG. 1, the pest redirect module 3 may include a redirect 30 that defines a path therein, and that has a first opening at one end thereof in spatial communication with the trapping opening 24 of the trapping module 2, and a second opening at another end thereof reaching out of the trapping module 2, so as to lure pests to move thereinto. In some examples, the redirect 30 may be detachably connected to the trapping module 2. In some examples, the pest redirect module 3 may further include a connecting component 34 disposed at the second opening of the redirect 30 distal from the trapping module 2, and a lure holder 32 (see FIG. 2) that is inserted into the connecting component 34 and that is fixed onto the redirect 30 using the connecting component 34. In some examples, the connecting component 34 may be tubular or funnel-shaped. Referring further to FIG. 2, an example lure holder 32 may include a lid 322 and four extending walls 324 connected to the lid 322. The lid 322 is for preventing raindrops from falling into the redirect 30. The extending walls 324 are for intercepting pests flying and coming into contact therewith. In some examples, the lure holder 32 may include a plurality of retaining holes 320 formed in the extending walls 324. Lure may be held by the lure holder 32 by virtue of the retaining holes 320, so that pests may be lured to fly toward the extending walls 324. Once a pest collides with one of the extending walls 324, the pest may then fall through the redirect 30 and into the trapping module 2. The lid 322 may further be used for preventing the pest from leaving the trapping module 2 through the redirect 30. It is noted that the example lure holder 32 in FIG. 2 is designed for catching Japanese beetles, and different structures may be employed for other pests. In some examples, the pest redirect module 3 itself may be configured as lure/stimuli that is attached to the trapping module 2 for luring the pests to enter the trapping chamber 20 via the trapping opening 24.

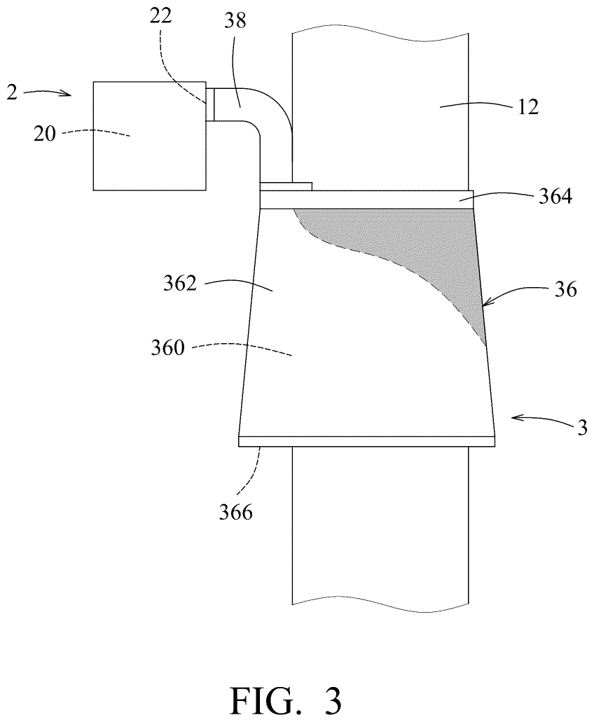

Referring to FIG. 3, in some examples, the pest redirect module 3 may be disposed on a columnar standing structure 12, and may include a mesh module 36 and a communication tube 38. The columnar standing structure 12 may be a trunk of a tree, a utility pole, a pillar, or the like. In the illustrated example, the mesh module 36 may include a main mesh body 362 that surrounds the columnar standing structure 12 and that cooperates with an outer surrounding surface of the columnar standing structure 12 to define a path 360 therebetween, and a fastening component 364 (e.g., a metal wire) that is used to fasten the main mesh body 362 onto the columnar standing structure 12. The example main mesh body 362 further cooperates with the columnar standing structure 12 to define an entrance opening 366 via which pests are able to move into the path 360. In some examples, the main mesh body 362 may be at least partially made from a mesh fabric, and may partially cling to the columnar standing structure 12 and be partially spaced apart from the columnar standing structure 12, so that the path 360 is defined between the columnar standing structure 12 and the portion of the main mesh body 362 that is spaced apart from the columnar standing structure 12 (i.e., the unshaded portion of the main mesh body 362 in FIG. 3). In such case, the pest(s) below the main mesh body 362 may be lured to move into the path 360. In some examples, the communication tube 38 is connected between and in spatial communication with the path 360 of the mesh module 36 and the trapping opening 24 of the trapping module 2, and the pest going into the path 360 is forced to move into the trapping module 2. In some examples, the communication tube 38 of the pest redirect module 3 may be configured as a bent tube or a straight tube, or may have other shapes. The trapping module 2 may be mounted to a supporting stand (not shown).

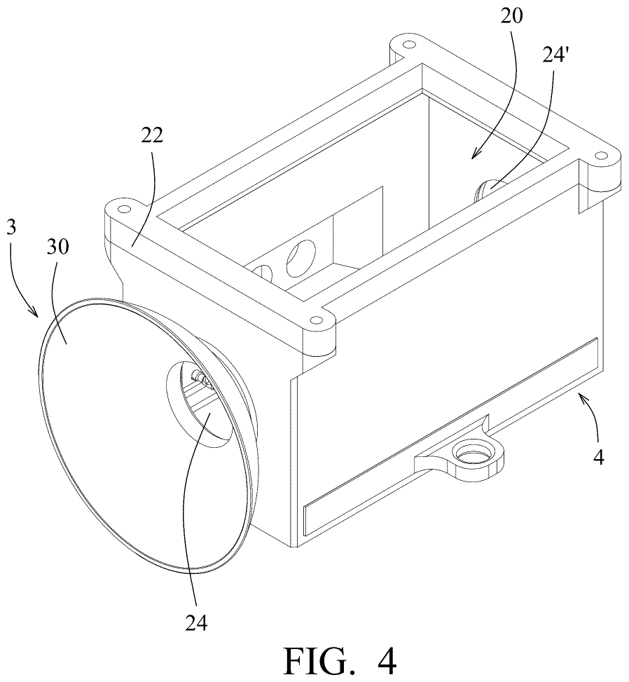

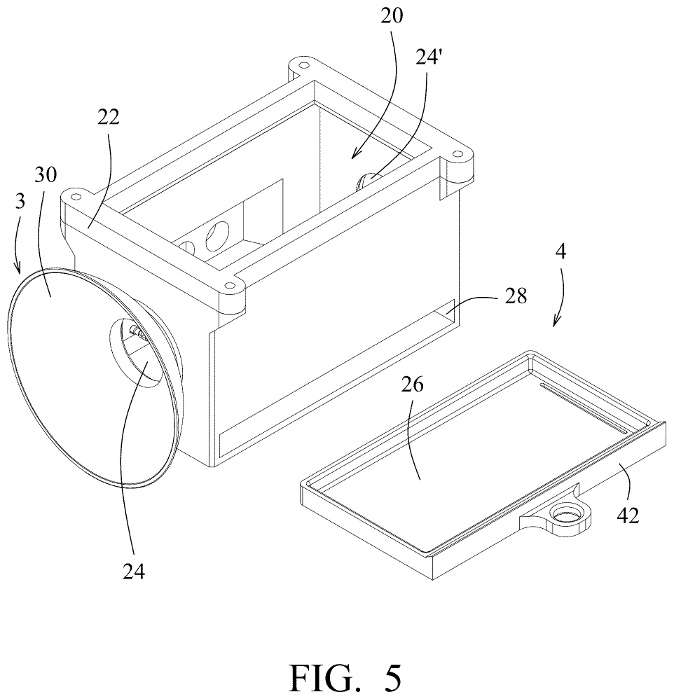

Referring to FIGS. 4 and 5, in some examples, the pest redirect module 3 may include a funnel-shaped redirect 30 that is connected to the trapping box 22 for luring pests to enter the trapping chamber 20 via the trapping opening 24. In some examples, the redirect 30 of the pest redirect module 3 may be detachably connected to the trapping box 22. In some examples, the trapping box 22 may further define an additional trapping opening 24′ that is in spatial communication with the trapping chamber 20, and the pest redirect module 3 may includes an additional funnel-shaped redirect (not shown) that is connected to the additional trapping opening 24′ of the trapping box 22. As such, the trapping box 22 is able to lure pests to move thereinto in two directions. It should be noted that, in FIGS. 4 and 5, for better understanding of the operation of the component(s), some wall segment(s) of the trapping box 22 is (are) omitted.

In some examples, the modular pest scouting system may further include a cleaning mechanism 4 that is disposed on the trapping module 2, and that is configured for removing the pests caught by the trapping box 22 or for renewing the trapping unit 26. With reference to FIGS. 4 and 5, in some examples, the trapping box 22 may be formed with a side opening 28 that is in spatial communication with the trapping chamber 20. An example cleaning mechanism 4 may include a drawer 42 that is removably mounted to the side opening 28. In the illustrated example, pests entering the trapping chamber 20 may fall onto a sticky board or liner disposed on the drawer 42. A user may pull out the drawer 42 to replace the used sticky board or liner with a new one after a period of time, so as to count and/or remove the pests after the period of time. In some examples, the trapping unit 26 may be configured as a sticky board or liner that is attached to an inner bottom surface of the drawer 42. The example cleaning mechanism 4 facilitates renewal of the example trapping unit 26.

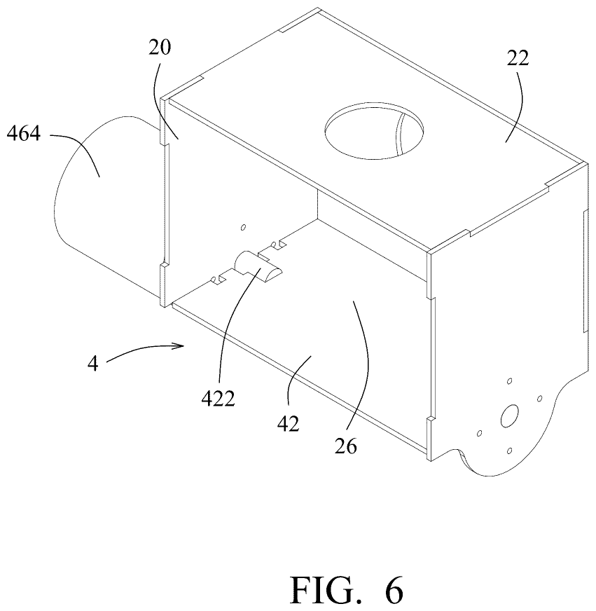

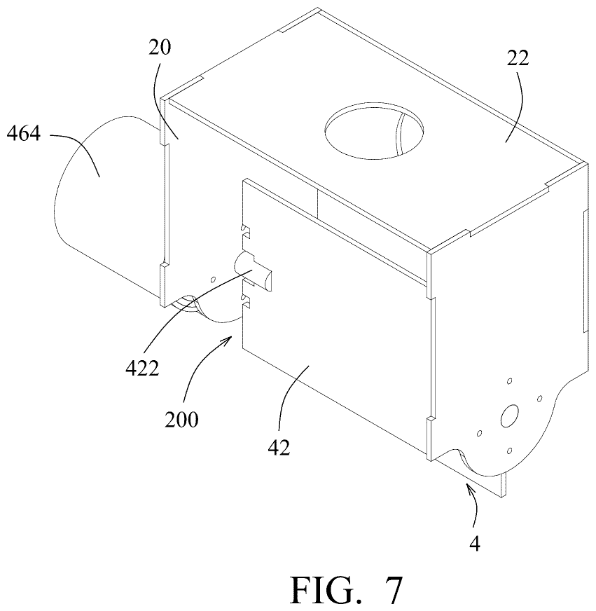

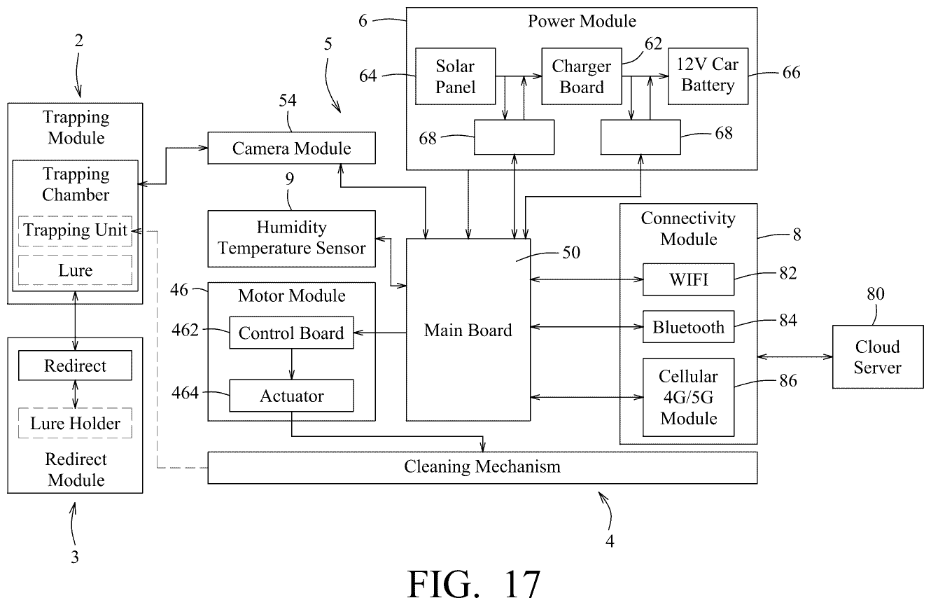

With reference to FIGS. 6 and 7, in some examples, the trapping box 22 may be formed with a bottom opening 200 (see FIG. 7) that is in spatial communication with the trapping chamber 20, and the cleaning mechanism 4 may include a revolving door 42 that removably blocks the bottom opening 200 of the trapping box 22. It should be noted that, in FIGS. 6 and 7, for better understanding of the operation of the component(s), some wall segment(s) of the trapping box 22 is (are) omitted. For example, the revolving door 42 may be rotatably connected to the trapping box 22, and is rotatable relative to the trapping box 22 between a blocking position in which the revolving door 42 blocks the bottom opening 200 of the trapping box 22 (see FIG. 6), and an opening position in which the revolving door 42 unblocks the bottom opening 200 of the trapping box 22 (see FIG. 7). Referring further to FIG. 17, in some examples, the modular pest scouting system may further include a monitoring module 5. The monitoring module 5 may include a main board 50 that includes a processor, and a motor module 46 for controlling movement of the revolving door 42. For example, the revolving door 42 may have a rod portion 422 that is rotatably mounted to the trapping box 22, and the motor module 46 is configured to rotate the rod portion 422 of the revolving door 42 so as to rotate the revolving door 42 between the blocking position and the opening position. In some examples, the motor module 46 may include a control board 462 that is connected to the main board 50, and an actuator 464 that is actuated by the control board 462, and that is connected to the rod portion 422 of the revolving door 42 for moving the revolving door 42. In some examples, the actuator 464 may be connected to the control board 462 via an I²C bus. In some examples, the revolving door 42 may be rotated by 90 degrees when being moved from the blocking position to the opening position, therefore causing the pests in the trapping chamber 20 to drop out. In some examples, a top surface of the revolving door 42 may be slippery, and may serve as the trapping unit 26. In some examples, the trapping unit 26 may be configured as a slippery layer that is attached to a top surface of the revolving door 42. The example cleaning mechanism 4 enables removal of the pests on the example trapping unit 26 when the revolving door 42 moves to the opening position, so as to facilitate renewal of the example trapping unit 26. In some examples, the actuator 464 may be configured as a step motor, a servo motor, a DC motor, or the like.

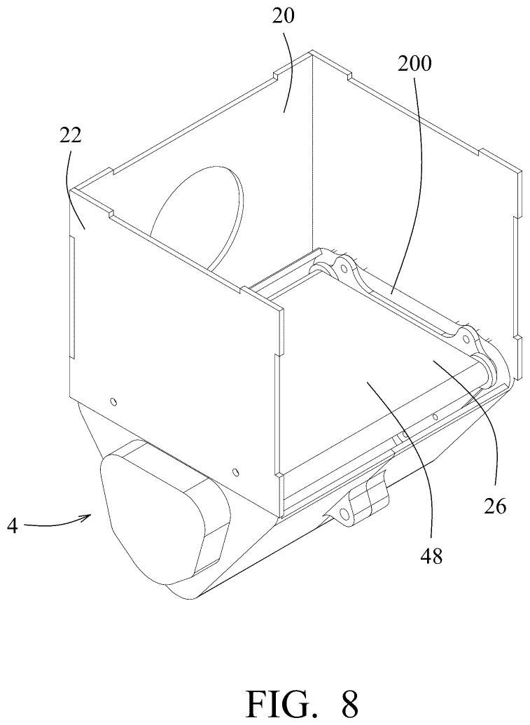

Referring to FIG. 8, in some examples, the trapping box 22 may be formed with a bottom opening 200 that is in spatial communication with the trapping chamber 20, and the cleaning mechanism 4 may include a conveying belt 48 that is disposed below the trapping module 2, that is connected to the motor module 46, and that substantially blocks the bottom opening 200 of the trapping module 2. It should be noted that, in FIG. 8, for better understanding of the operation of the component(s), some wall segment(s) of the trapping box 22 is (are) omitted. In some examples, the conveying belt 48 may be elongated and may have a sticky surface. A portion of the sticky surface of the example conveying belt 48 faces the trapping chamber 20 to retain the pests falling from the trapping module 2. After a certain period of time, the conveying belt 48 is transported such that the portion of the sticky surface with pest(s) stuck thereon leaves the trapping chamber 20, and a clean portion of the sticky surface moves into the trapping chamber 20 to retain pests for another duration. In some examples, the portion of the sticky surface of the example conveying belt 48 that facing the trapping chamber 20 may serve as the trapping unit 26. After the conveying belt 48 is transported such that the used portion of the sticky surface with pest(s) stuck thereon leaves the trapping chamber 20 and that a clean portion of the sticky surface moves into the trapping chamber 20, the clean portion of the sticky surface that facing the trapping chamber 20 may serve as the trapping unit 26. The example cleaning mechanism 4 facilitates renewal of the example trapping unit 26.

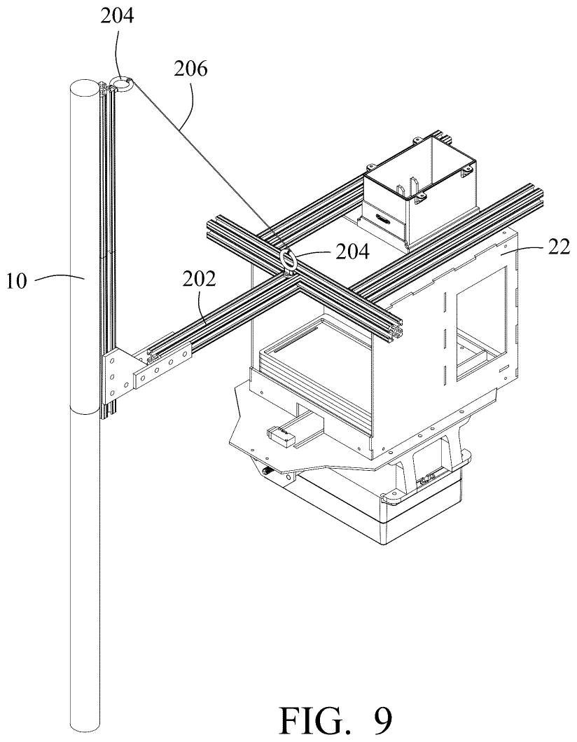

Referring to FIG. 9, in some examples, the trapping module 2 may further include an arm 202 that is rotatably mounted to the supporting stand 10, and that is fixedly connected to the trapping box 22. In some examples, the trapping module 2 may further includes two fasteners 204 (e.g., eye bolts) that are respectively mounted to the supporting stand 10 and the arm 202, and a wire 206 (e.g., a robust metal wire) that is tied between the fasteners 204. In some examples, a distance between the fasteners 204 may be adjustable by loosening the wire 206 relative to at least one of the fasteners 204 and by moving the wire 206 relative to the one of the fasteners 204. By such, the orientation of the arm 202 relative to the supporting stand 10 can be adjusted so as to keep the trapping box 22 level. After adjustment of the orientation of arm 202, the wire 206 may be tightened relative to the one of the fasteners 204 so as to maintain the orientation of the arm 202.

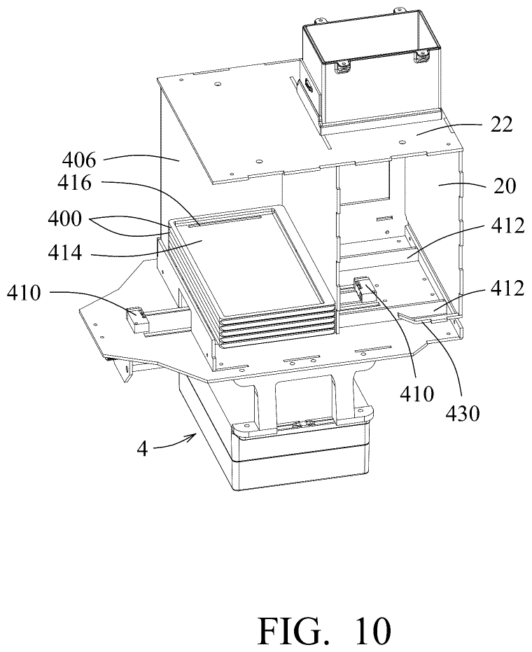

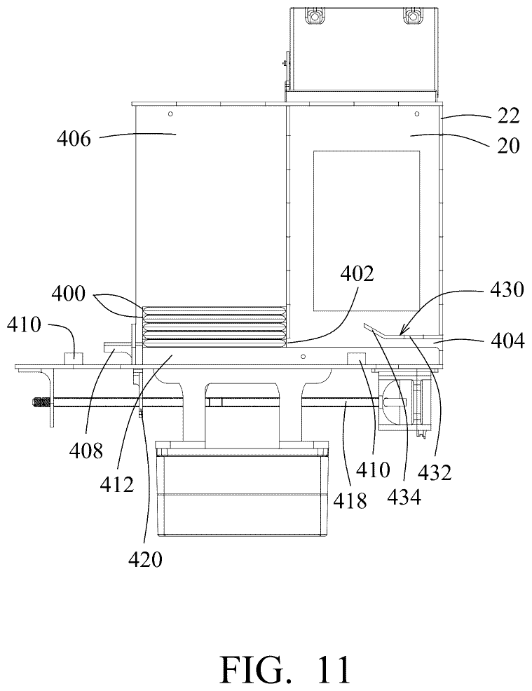

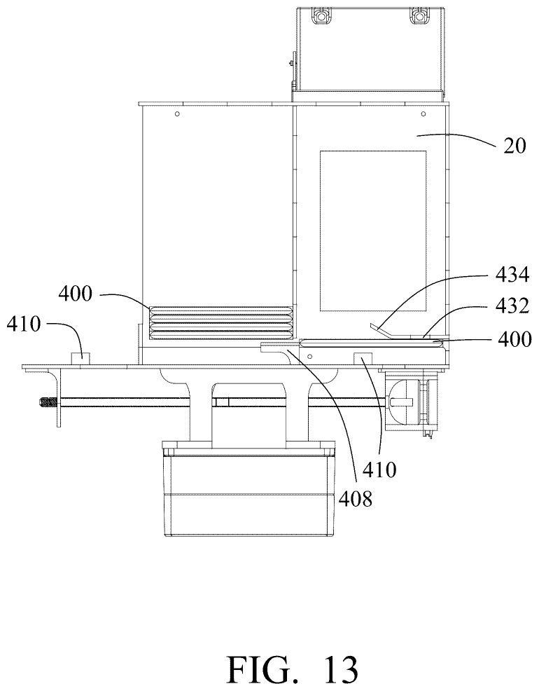

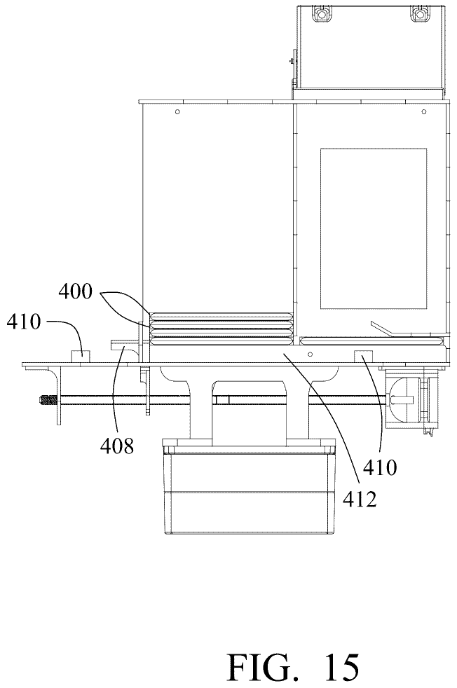

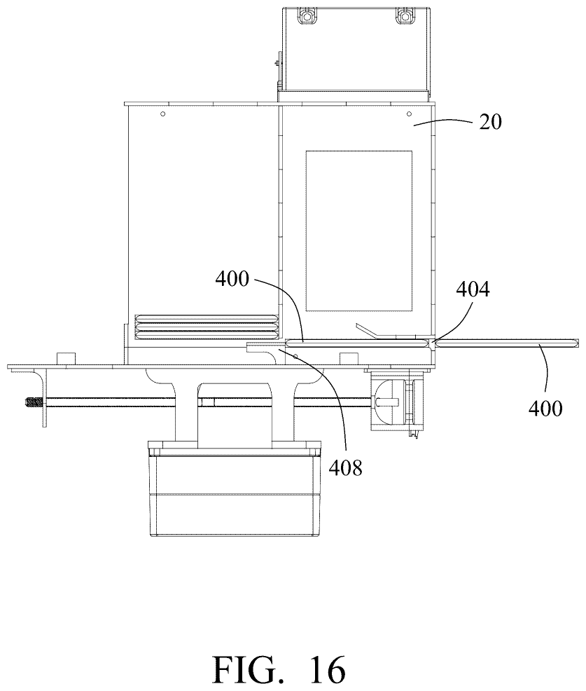

Referring further to FIGS. 10 and 11, in some examples, the cleaning mechanism 4 may include a plurality of trays 400, and a pusher 408 that is movable relative to the trapping box 22 between an initial position (see FIGS. 11 and 15) and a pushing position (see FIGS. 13 and 16) for pushing the trays 400 into the trapping chamber 20 one at a time. In some examples, the trapping box 22 may be formed with a tray entrance 402 and a tray exit 404 that are in spatial communication with the trapping chamber 20. It should be noted that, in FIGS. 9 and 10, for better understanding of the operation of the component(s), some wall segment(s) of the trapping box 22 is (are) omitted. In some examples, each of the trays 400 may have an indentation region 414, and a drain hole 416 that is in spatial communication with the indentation region 414. In some examples, an inner bottom surface of the indentation region 414 of each of the trays 400 may have a slight slope for directing rainwater to drain through the drain hole 416. In some examples, the inner bottom surface of the indentation region 414 of each of the trays 400 may be sticky for trapping and observing pests. In some examples, the cleaning mechanism 4 may further include two limit switches 410 for limiting the range of movement of the pusher 408 between the initial position and the pushing position. The example limit switches 410 allow for precise and consistent pusher control allowing the cleaning mechanism 4 to operate exactly the same way each time it runs. In some examples, the cleaning mechanism 4 may further include two support rails 412 that support the trays 400 for reducing friction during the movement of the trays and for preventing interference between the trays 400 and other components. In some examples, initially, the trays 400 may be stacked on one another, and may be located out of the trapping chamber 20. In some examples, the cleaning mechanism 4 may define a tray chamber 406 for retaining the trays 400. In some examples, the cleaning mechanism 4 may further include a leadscrew 418 that is coupled to the actuator 464, and a nut 420 that meshes with the leadscrew 418 and that is coupled to the pusher 408. By such, the leadscrew 418 is driven by the actuator 464 (see FIG. 17) to move the pusher 408 between the initial position and the pushing position. In some examples, the actuator 464 (see FIG. 17) may be configured as a linear actuator that moves the pusher 408 between the initial position and the pushing position. In some examples, the cleaning mechanism 4 may further include a guiding component 430 having a first part 432 that extends horizontally from a wall segment of the trapping box 22, and a second part 434 that extends from the first part in an upward angle (e.g., about 40-50 degrees).

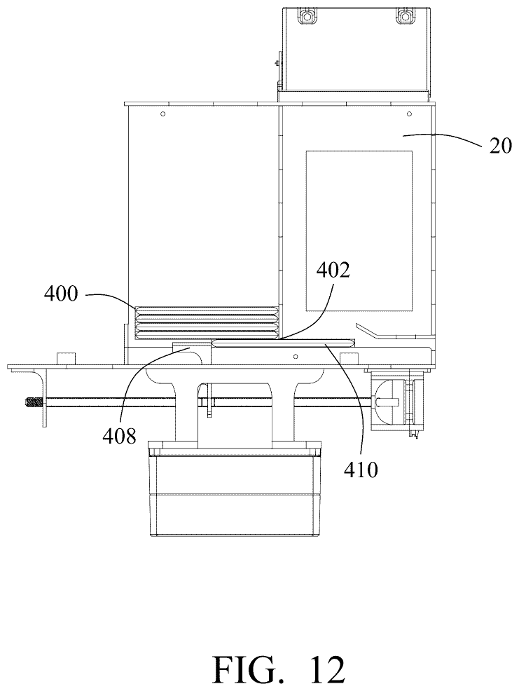

Referring further to FIG. 12, in some examples, when the pusher 408 moves toward the pushing position, a bottommost one of the trays 400 is pushed into the trapping chamber 20 via the trap entrance 402 by the pusher 408.

Referring further to FIG. 13, in some examples, when the pusher 408 reaches the pushing position, the bottommost one of the trays 400 is wholly pushed into the trapping chamber 20, and the right one of the limit switches 410 in FIG. 13 detects the position of the pusher 408 for stopping further movement of the pusher 408 away from the left one of the limit switches 410 in FIG. 13.

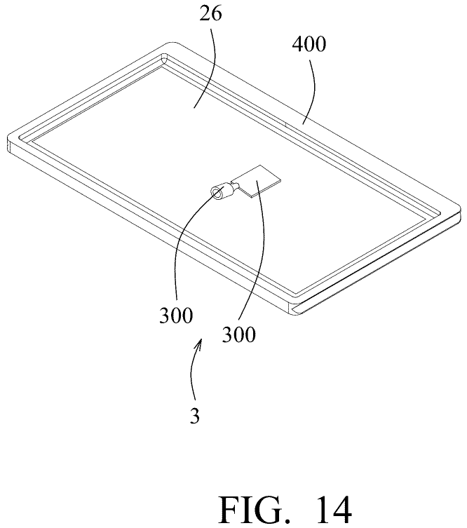

In some examples, the cleaning mechanism 4 may further include a plurality of sticky boards or liners that are respectively attached to the inner bottom surfaces of the trays 400. Referring to further FIG. 14, in some examples, the sticky board or liner that is attached to the tray 400 in the trapping chamber 20 may serve as the trapping unit 26. In some examples, the redirect module 3 may include at least one lure component 300 that is attached to the example trapping unit 26. In some examples, the lure component 300 May be configured as a plastic object filled with pheromone. In some examples, when a temperature is increased over a threshold, the pheromone may be released from the example lure component 300 into the air for luring pests to move into the trapping chamber 20. The example redirect module 3 in FIG. 14 include two lure components 300 that may release different types of pheromones.

With reference to FIGS. 10, 13 and 14 again, in some examples, the guiding component 430 is disposed at a height that is capable of containing a combined height of the tray 400, the trapping unit 26 (i.e., the sticky board or liner) and the lure components 300 (e.g., slightly larger than the combine height to accommodate the presence of the trapping unit 26 and the lure components 300). In some examples, the guiding component 430 is spaced apart from the support rails 412, and a height of a space between the guiding component 430 and the support rails 412 is slightly larger than the combine height to accommodate the presence of the trapping unit 26 and the lure components 300. As such, when the pusher 408 moves from the initial position toward the pushing position to push the bottommost one of the trays 400, the bottommost one of the trays 400 can be sequentially guided by the second part 434 and the first part 432 of the guiding component 430 to be secured at a predetermined position in the trapping chamber 20 without bringing the potential issue of the tray being jammed or misplaced.

Referring further to FIG. 15, in some examples, when the pusher 408 moves back to the initial position, the remaining trays 400 fall onto the support rails 412 and are supported by the support rails 412. In some examples, when the pusher 408 reaches the initial position, the left one of the limit switches 410 in FIG. 15 detects the position of the pusher 408 for stopping further movement of the pusher 408 away from the right one of the limit switches 410 in FIG. 15.

After the tray 400 in the trapping chamber 20 serves to capture pests for a certain period of time, it may need to be replaced by a new one. Referring further to FIG. 16, in some examples, when the pusher 408 moves toward the pushing position again, the bottommost one of the remaining trays 400 is pushed by the pusher 408 to enter the trapping chamber 20, and pushes the used tray 400 out of the trapping chamber 20 via the trap exit 404. The example cleaning mechanism 4 facilitates renewal of the example trapping unit 26.

In some examples, the monitoring module 5 (see FIG. 17) may be disposed near the trapping module 2, and may include different electronic devices (e.g., microprocessors, electric circuitry on a print circuit board, etc.) to provide different functions. For example, the monitoring module 5 may include a main board 50 that includes a processor, and that is configured to record different statistics related to the pest(s) that are caught in the trapping module 2 (e.g., counting for population).

In some examples, the monitoring module 5 may further include a power module 6 (see FIG. 17) for providing power to the components of the modular pest scouting system. Specifically, the power module 6 may include a charger board 62 (e.g., a solar panel charger board) connected to the main board 50, and a solar panel 64 connected to the charger board 62. The solar panel 64 is configured to convert solar power into electrical power. The charger board 62 is configured to receive the electrical power generated by the solar panel 64 and to supply the electrical power to the main board 50 and other components with a suitable voltage (e.g., 12 volts), such as a car battery 66. In some examples, the power module 6 may be connected to the main board 50 via a connector (e.g., a micro USB interface). In some examples, the power module 6 may further include at least one sensor 68 for monitoring voltage/current between the components of the power module 6. In some examples, the power module 6 may further include two INA219 sensors 68 that are connected to the main board 50 respectively via two I²C bus.

In some examples, the monitoring module 5 may further include a camera module 54 that is connected to the main board 50 for capturing images inside the trapping module 2 for enabling the monitoring module 5 to record the statistics. In some examples, the monitoring module 5 may further include a power module 6 that is connected to the main board 50 and that supplies electrical power to the camera module 54 via the main board 50. In some examples, the main board 50 may be stored with an object detection neural network (or an object detection model) that is pre-trained. By executing the object detection neural network, the main board 50 may be able to count the number of pests in the trapping module 2. In some examples, the main board 50 may be stored with a prediction neural network (or a prediction model) that is pre-trained. The main board 50 may execute the prediction neural network using the statistics recorded in order to provide relevant management suggestions associated with pest management (e.g., what the statistic indicates, and/or what actions to take). In some examples, the camera module 54 may be connected to the main board 50 via a connector (e.g., a Camera Serial Interface (CSI), a Serial Peripheral Interface (SPI) or a USB interface).

In some examples, the monitoring module 5 may further include a connectivity module 8 (see FIG. 7) that provides communication capacity to other devices. For example, the connectivity module 8 may include connectivity component(s) that supports connection(s) such as 2G, 3G, 4G, 5G, LTE Cat M1, NB-IoT, 4G LTE, 5G Sub-6 GHz, 5G Millimeter-wave, Long-Range (LoRa), SigFox, Ingenu, Weightless, Zigbee/IEEE 802.15.4, Thread, Bluetooth®, Z-Wave, WiFi, WirelessHART or RFID/NFC. The connectivity component(s) may be built in the main board 50, or may be externally connected to the main board 50. In the illustrated example, the connectivity module 8 includes a Wi-Fi component 82 and a Bluetooth® component 84 that may be built in the main board 50, and a cellular 4G/5G module 86 that may be externally connected (via, for example, a USB interface) to the main board 50. As such, the main board 50 may be configured to communicate with a remote device (e.g., a server, a portable device, and so on) via the connectivity module 8. After the processor of the main board 50 generates the statistics and/or the management suggestions, the connectivity module 8 is configured to output the statistics and/or the management suggestions. In some examples, the main board 50 may communicate with a cloud server 80, which is stored with a pre-trained object detection neural network and/or a pre-trained prediction neural network, via the connectivity module 8. For example, the main board 50 may upload an image captured by the camera module 54 to the cloud server 80 for counting the number of pests in the trapping module 2 to obtain statistics related to the pests. The statistics may be stored in the cloud server 80 and/or may be retrieved by the main board 50. The main board 50 may upload the statistics recorded therein to the cloud server 80 or access the statistics recorded in the cloud server 80 for obtaining relevant management suggestions associated with pest management. 2

In some examples, the monitoring module 5 may further include a humidity/temperature sensor 9 (see FIG. 7) for detecting humidity and temperature around the location of the modular pest scouting system. The processor of the main board 50 may further implement the above calculations based on the detected humidity and temperature. In some examples, the humidity/temperature sensor 9 may be connected to the main board 50 via an I²C bus.

One effect of the disclosure is that a plurality of configurationally different pest redirect modules 3 may be produced. Each of these pest redirect modules 3 is designed for catching one or more specific types of pests. As such, the modular pest scouting system may be easily reconfigured by switching the pest redirect module 3, and may be applied to different areas (e.g., different farms with various crops) that may be infested with different pests. With different pest redirect modules 3 that can be easily detached and reattached onto the trapping module 2, the modular pest scouting system may be seen as a “plug-and-play” apparatus.

Additionally, the cleaning mechanism 4 may be controlled by the processor of the main board 50 to activate, thereby cleaning up the trapping module 2 periodically (e.g., once a week). As such, the main board 50 is enabled to perform the counting of the pest(s) caught in the trapping module 2 each week. This may be particularly useful in the case that it is desired to obtain a daily trend of the population of the pests. It is noted that in other cases, the frequency in which the cleaning mechanism 4 cleans the trapping module 2 may be varied (e.g., once per day) to accommodate other demands. For farmers, the cleaning mechanism 4 saves time on maintenance and changing out the sticky boards. For pest-management service providers, the cleaning mechanism 4 increases the accuracy of machine learning for identification of pests or insects. The monitoring module 5 enables remote monitoring of the modular pest scouting system.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A modular pest scouting system, comprising:
a trapping module adapted for catching pests; and
a pest redirect module detachably attached to the trapping module for luring the pests to move toward the trapping module.

2. The modular pest scouting system as claimed in claim 1, wherein:
the trapping module defines a trapping chamber, and a trapping opening in spatial communication with the trapping chamber;
the pest redirect module defines a path that is in spatial communication with the trapping module via the trapping opening, and has an opening that is distal from the trapping module and that enables the pests to enter the trapping module.

3. The modular pest scouting system as claimed in claim 2, wherein the pest redirect module includes:
a redirect that has one end connected to the trapping module via the trapping opening, and another end reaching out of the trapping module; and
a lure holder that is connected to the another end of the hollow tube, the lure holder including a lid and a plurality of extending walls that are connected to the lid.

4. The modular pest scouting system as claimed in claim 2, wherein the pest redirect module is mounted to a columnar standing structure, and includes:
a mesh module that includes a main mesh body that cooperates with the columnar standing structure to define the path; and
a fastening component that fastens the main mesh body onto the columnar standing structure.

5. The modular pest scouting system as claimed in claim 1, further comprising a trapping unit associated with the trapping module for ensuring the pests caught by the trapping module to remain on trapping module.

6. The modular pest scouting system as claimed in claim 5, wherein the trapping unit includes one of:
a sticky board disposed on an inner bottom of the trapping module, the sticky board containing adhesive thereon; and
a slippery layer disposed on an inner surface of the trapping module.

7. The modular pest scouting system as claimed in claim 5, further comprising a cleaning mechanism associated with the trapping module for renewing the trapping unit.

8. The modular pest scouting system as claimed in claim 1, further comprising a monitoring module including:
a main board that includes a processor;
a camera module that is connected to the main board, the camera module being configured to capture images inside the trapping module; and 8
a connectivity module that is connected to the main board, and configured to be controlled by the processor to communicate with a remote electronic device;
wherein the processor is configured to access an object detection model which is executed on the images to record statistics associated with a number of pests inside the trapping module.

9. The modular pest scouting system as claimed in claim 8, wherein the processor is further configured to access a prediction model which is executed on the statistics, and which output at least one management suggestion associated with pest management.

10. The modular pest scouting system as claimed in claim 8, wherein the monitoring module further includes a power module that includes:
a solar panel configured to convert solar power to electrical power; and
a charger board connected to the main board and the solar panel, and configured to receive the electrical power and supply the electrical power to the main board with a predetermined voltage.

11. A modular pest scouting system, comprising:
a trapping module adapted for catching pests;
a trapping unit associated with the trapping module for ensuring the pests caught by the trapping module to remain on trapping module; and
a cleaning mechanism associated with the trapping module for renewing the trapping unit.

12. The modular pest scouting system as claimed in claim 11, wherein the cleaning mechanism includes a drawer that is removably mounted to the trapping module.

13. The modular pest scouting system as claimed in claim 11, wherein the cleaning mechanism includes a revolving door that removably blocks a bottom opening of the trapping module.

14. The modular pest scouting system as claimed in claim 13, further comprising a monitoring module that includes:
a main board including a processor; and
a motor module connected to the processor;
wherein the revolving door of the cleaning mechanism is rotatably connected to a bottom side of the trapping module and controlled by the motor module to rotate.

15. The modular pest scouting system as claimed in claim 11, wherein the cleaning mechanism includes a conveying belt that is located at a bottom side of the trapping module.

16. The modular pest scouting system as claimed in claim 15, wherein trapping module defines a trapping chamber, the conveying belt of the cleaning mechanism having a sticky surface that has a portion facing the trapping chamber, and another portion located out of the trapping chamber.

17. The modular pest scouting system as claimed in claim 15, further comprising:
a main board including a processor; and
a motor module connected to the processor;
wherein the conveying belt of the cleaning mechanism is connected to the motor module, is controlled by the motor module to move.

18. The modular pest scouting system as claimed in claim 11, wherein:
the trapping module defines a trapping chamber; and
the cleaning mechanism includes a plurality of trays, and a pusher that pushes the trays into the trapping chamber one at a time.

19. The modular pest scouting system as claimed in claim 18, further comprising:
a main board including a processor; and
a motor module connected to the processor;
wherein the pusher of the cleaning mechanism is connected to the motor module, is controlled by the motor module to move.

20. A modular pest scouting system adapted to be fastened onto a supporting stand, comprising:
a trapping module adapted for catching pests, the trapping module including a trapping box, and an arm that is adapted to be rotatably mounted to the supporting stand and that is fixedly connected to the trapping box.

21. The modular pest scouting system as claimed in claim 20, wherein the trapping module further includes two fasteners that are respectively mounted to the supporting stand and that arm, and a wire that is releasably tied between the fasteners.

22. The modular pest scouting system as claimed in claim 20, further comprising:
a trapping unit associated with the trapping module for ensuring the pests caught by the trapping module to remain on trapping module; and
a cleaning mechanism associated with the trapping module for renewing the trapping unit.

23. The modular pest scouting system as claimed in claim 22, wherein:
the trapping module defines a trapping chamber; and
the cleaning mechanism includes a plurality of trays, and a pusher that pushes the trays into the trapping chamber one at a time.

24. The modular pest scouting system as claimed in claim 23, further comprising:
a main board including a processor; and
a motor module connected to the processor;
wherein the pusher of the cleaning mechanism is connected to the motor module, is controlled by the motor module to move.

25. The modular pest scouting system as claimed in claim 24, wherein the cleaning mechanism further includes two limit switches that are respectively located at two opposite side of the pusher for limiting the range of movement of the pusher.

26. The modular pest scouting system as claimed in claim 23, wherein the cleaning mechanism further includes:
at least one support rail that is disposed in the trapping chamber for supporting the trays; and
a guiding component that is disposed in the trapping chamber and that is spaced apart from the at least one support rail, the guiding component having a first part that extends horizontally from a wall segment of the trapping module, and a second part that extends from the first part in an upward angle.
